(19) United States
(12) Patent Application Publication
(10) Pub. No.: US 2025/0211042 A1
(43) Pub. Date: Jun. 26, 2025

(54) ROTATING ELECTRIC MACHINE CORE AND ROTATING ELECTRIC MACHINE

(71) Applicant: DENSO CORPORAITON, Kariya-city (JP)

(72) Inventors: Kenichi AOYAMA, Kariya-city (JP); Noriyuki Suzuki, Kariya-city (JP)

(73) Assignee: DENSO CORPORAITON, Kariya-city (JP)

(21) Appl. No.: 19/078,867

(22) Filed: Mar. 13, 2025

Related U.S. Application Data
(63) Continuation of application No. PCT/JP2023/030129, filed on Aug. 22, 2023.

(30) Foreign Application Priority Data
Sep. 13, 2022 (JP) 2022-145329

(51) Int. Cl. H02K 1/276; H02K 21/16

(52) U.S. Cl. CPC H02K 1/2773; H02K 21/16; H02K 2213/03

(57) ABSTRACT

A core for a rotating electric machine is formed by laminating a plurality of core sheet in an axial direction. Each of the core sheets has a first fitting portion and a second fitting portion. One of the first fitting portion and the second fitting portion has a convex shape protruding in the axial direction. The other of the first fitting portion and the second fitting portion has a concave shape recessed in the axial direction. An axially-adjacent pair of the core sheets are joined together by fitting the first fitting portion of one of the pair of the core sheets and the second fitting portion of the other of the pair of the core sheets to each other. The first fitting portion and the second fitting portion provided in a same one of the core sheets are located at positions not overlapping each other in the axial direction.

### CROSS-REFERENCE TO RELATED APPLICATIONS

The present application is a continuation application of International Application No. PCT/JP2023/030129 filed on Aug. 22, 2023, which is based on and claims priority from Japanese Patent Application No. 2022-145329 filed on Sep. 13, 2022. The entire contents of these applications are incorporated by reference into the present application.

### BACKGROUND

### 1 Technical Field

The present disclosure relates to rotating electric machine cores and rotating electric machines.

### 2 Description of Related Art

There is known, for example as disclosed in Japanese Patent Application Publication No. JP 2022-122982 A, a rotor core of a rotating electric machine. The rotor core includes a plurality of core sheets laminated in an axial direction. Each of the core sheets has protrusions and recesses formed by press working. Specifically, for each of the core sheets, a punch is pressed axially against a first surface of the core sheet, thereby forming the recesses in the first surface and the protrusions on a second surface of the core sheet which is on an opposite side to the first surface. Each axially-adjacent pair of the core sheets are joined together by fitting the protrusions of one of the pair of the core sheets respectively into the recesses of the other of the pair of the core sheets. Moreover, a rotor disclosed in the aforementioned patent document has magnetic poles formed by permanent magnets embedded in the rotor core.

### SUMMARY

In the known rotor described above, to realize a skew structure in which the magnetic poles are circumferentially offset with change in the positions thereof in the axial direction, it is necessary to form each of the core sheets so that the protrusions and the recesses on the back side thereof in the same core sheet are offset in the circumferential direction. Moreover, it is possible to make the protrusions and the recesses on the back side thereof offset in the circumferential direction by shifting a die and a punch, which are used in the press working for forming the protrusions and the recesses, in the circumferential direction. However, in the press working, it is difficult to make the amount of circumferential offset between the protrusions and the recesses large. Consequently, constraints will be imposed on the design of the rotor core, such as the necessity of increasing the axial length of the rotor core for securing a desired amount of circumferential offset of the magnetic poles in the skew structure.

The present disclosure has been accomplished in view of the above problem.

According to a first aspect of the present disclosure, there is provided a core for a rotating electric machine. The core is formed by laminating a plurality of core sheets in an axial direction. Each of the core sheets has a plurality of magnetic-pole forming parts provided at equal intervals in a circumferential direction. Moreover, each of the core sheets has a first fitting portion and a second fitting portion. One of the first fitting portion and the second fitting portion has a convex shape protruding in the axial direction. The other of the first fitting portion and the second fitting portion has a concave shape recessed in the axial direction. An axially-adjacent pair of the core sheets are joined together by fitting the first fitting portion of one of the pair of the core sheets and the second fitting portion of the other of the pair of the core sheets to each other. The first fitting portion and the second fitting portion provided in a same one of the core sheets are located at positions not overlapping each other in the axial direction.

According to a second aspect of the present disclosure, there is provided a rotating electric machine which includes a rotor having a rotor core and a stator having a stator core. At least one of the rotor core and the stator core is formed by laminating a plurality of core sheets in an axial direction. Each of the core sheets has a plurality of magnetic-pole forming parts provided at equal intervals in a circumferential direction. Moreover, each of the core sheets has a first fitting portion and a second fitting portion. One of the first fitting portion and the second fitting portion has a convex shape protruding in the axial direction. The other of the first fitting portion and the second fitting portion has a concave shape recessed in the axial direction. An axially-adjacent pair of the core sheets are joined together by fitting the first fitting portion of one of the pair of the core sheets and the second fitting portion of the other of the pair of the core sheets to each other. The first fitting portion and the second fitting portion provided in a same one of the core sheets are located at positions not overlapping each other in the axial direction.

In the above-described core and rotating electric machine, each of the core sheets is configured so that the first fitting portion is not involved in the forming of the second fitting portion. Therefore, the degree of freedom in setting the formation position of the second fitting portion is high. Consequently, it becomes possible to easily secure the amount of circumferential offset of a skew structure of the core.

### BRIEF DESCRIPTION OF THE DRAWINGS

FIG. 1 is a configuration diagram of a rotating electric machine according to an embodiment.

FIG. 2 is a plan view showing part of a core sheet according to the embodiment.

FIG. 3 is a plan view showing a second magnetic-pole forming part of the core sheet according to the embodiment.

FIG. 4 is an explanatory diagram illustrating the manner of laminating core sheets of a rotor core according to the embodiment.

FIG. 5 is an explanatory diagram illustrating the manner of joining between the core sheets of the rotor core according to the embodiment.

FIG. 6 is a schematic diagram illustrating a skew structure of magnetic poles of a rotor according to the embodiment.

FIG. 7 is a schematic diagram illustrating a skew structure of magnetic poles of a rotor according to a modification.

FIG. 8 is a schematic diagram illustrating a skew structure of magnetic poles of a rotor according to another modification.

FIG. 9 is a cross-sectional view showing a second fitting portion of a core sheet according to another modification.

FIG. 10 is a perspective view of a core sheet according to another modification.

### DESCRIPTION OF EMBODIMENTS

Hereinafter, an embodiment of a rotating electric machine core and a rotating electric machine will be described.

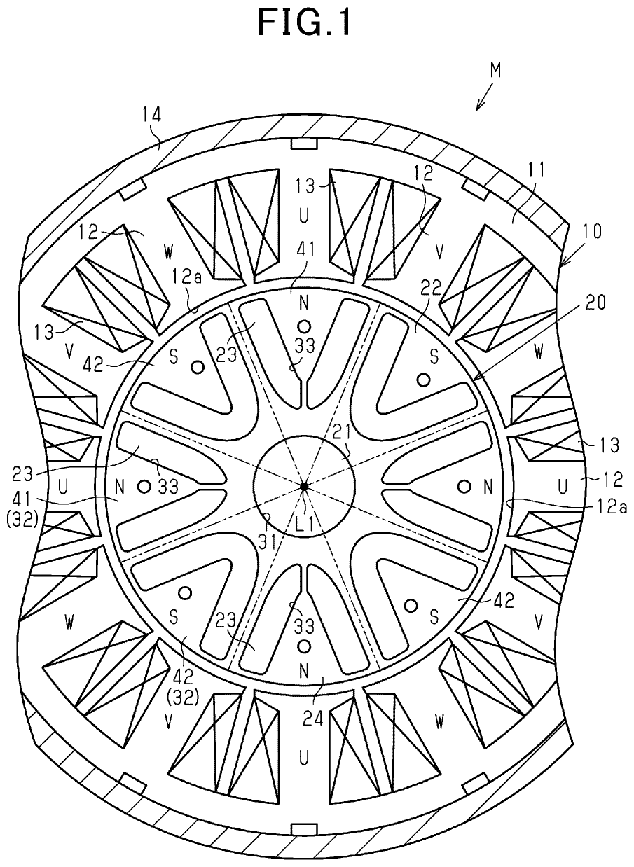

As shown in FIG. 1, a rotating electric machine M according to the present embodiment is configured as an interior permanent magnet brushless motor. The rotating electric machine M includes a substantially annular stator 10 and a substantially cylindrical rotor 20 that is rotatably arranged in a space radially inside the stator 10. The stator 10 is configured to apply a rotating magnetic field to the rotor 20.

### (Stator 10)

The stator 10 includes a substantially annular stator core 11. The stator core 11 is formed of a magnetic metal material. For example, the stator core 11 may be formed by laminating a plurality of core sheets in a direction along a central axis L1. The core sheets may be implemented by, for example, magnetic steel sheets. The stator core 11 has a plurality (e.g., twelve) of teeth 12. The teeth 12 extend radially inward and are arranged at equal intervals in a circumferential direction. All the teeth 12 are identical in shape to each other. Each of the teeth 12 has a substantially T-shaped radially inner end portion (i.e., distal end portion) and a distal end surface 12a formed in an arc shape along an outer circumferential surface of the rotor 20.

Windings 13 are wound around the teeth 12 in, for example, a concentrated winding manner. The windings 13 are connected in three phases to respectively function as a U-phase, a V-phase and a W-phase as shown in FIG. 1. Upon supply of electric power to the windings 13, the stator 10 generates a rotating magnetic field, thereby driving the rotor 20 to rotate. In addition, in the stator 10, an outer circumferential surface of the stator core 11 is fixed to an inner circumferential surface of a housing 14.

### (Rotor 20)

The rotor 20 includes a rotating shaft 21, a rotor core 22 and a plurality of permanent magnets 23. The rotor core 22 has a substantially cylindrical shape. The rotating shaft 21 is inserted in a central part of the rotor core 22. The permanent magnets 23 are embedded in the rotor core 22. More particularly, in the present embodiment, there are provided eight permanent magnets 23 in the rotor core 22. The rotor 20 is rotatably arranged with respect to the stator 10, with the rotating shaft 21 supported by bearings (not shown) provided in the housing 14.

### (Configuration of Core Sheets 24)

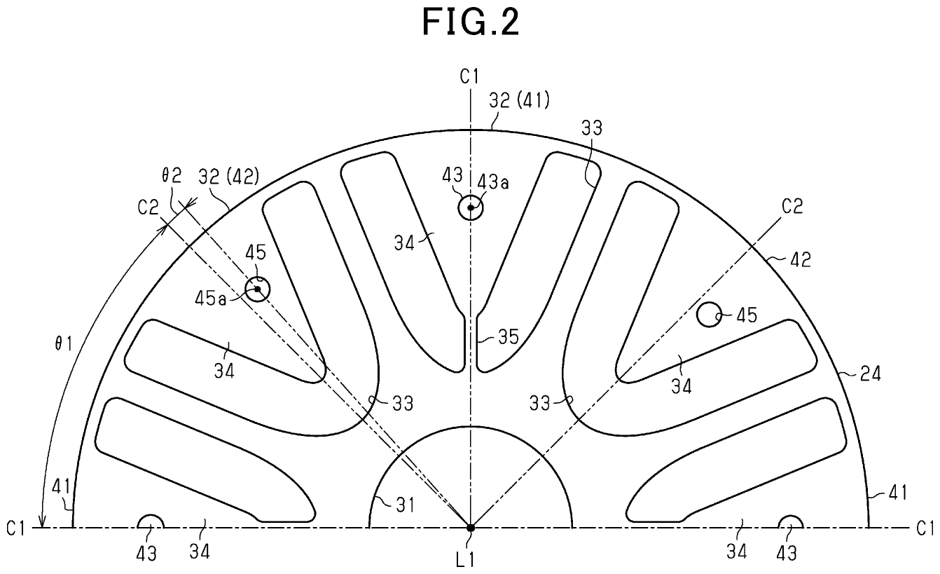

The rotor core 22 is formed by laminating a plurality of core sheets 24 as shown in FIG. 2 in the axial direction. The core sheets 23 may be implemented by, for example, magnetic steel sheets that are formed of a magnetic metal material. In the present embodiment, all the core sheets 24 are identical in shape to each other.

As shown in FIG. 2, each of the core sheets 24 has a shaft insertion hole 31 in which the rotating shaft 21 is inserted, and a plurality of magnetic-pole forming parts 32 located around the shaft insertion hole 31. The magnetic-pole forming parts 32 are provided at equal intervals in the circumferential direction of the rotor core 22. It should be noted that in the following explanation, the circumferential direction of the rotor core 22, the axial direction of the rotor core 22 and the radial direction of the rotor core 22 will be respectively simply referred to as the circumferential direction, the axial direction and the radial direction as appropriate.

In the present embodiment, the rotor 20 is configured with eight poles. That is, each of the core sheets 24 has eight magnetic-pole forming parts 32 provided at intervals of 45° in the circumferential direction. Each of the eight magnetic-pole forming parts 32 has a magnet hole 33. Each of the magnet holes 33 of the magnetic-pole forming parts 32 is a hole which penetrates the core sheet 24 in the axial direction. All the magnet holes 33 of the magnetic-pole forming parts 32 are identical in shape to each other. In each of the magnet holes 33 of the magnetic-pole forming parts 32, there is provided a corresponding one of the permanent magnets 23. Moreover, each of the magnet holes 33 of the magnetic-pole forming parts 32 has a folded shape that is convex radially inward as viewed in the axial direction. More particularly, each of the magnet holes 33 of the magnetic-pole forming parts 32 has a substantially V-shape as viewed in the axial direction. In addition, the eight magnet holes 33 are provided at equal intervals in the circumferential direction.

Each of the eight magnetic-pole forming parts 32 has an outer core portion 34 on a radially outer side of the magnet hole 33. The outer core portion 34 is a portion of the core sheet 24 which is formed inside the folded substantially V-shape of the magnet hole 33. The outer core portion 34 functions as a portion facing the stator 10 to generate reluctance torque. When viewed in the axial direction, the outer core portion 34 has a substantially triangular shape with one vertex oriented toward the central axis L1 of the core sheet 24.

In the present embodiment, the eight magnetic-pole forming parts 32 consist of four first magnetic-pole forming parts 41 and four second magnetic-pole forming parts 42. The four first magnetic-pole forming parts 41 and the four second magnetic-pole forming parts 42 are arranged alternately in the circumferential direction.

Moreover, in the present embodiment, each of the first magnetic-pole forming parts 41 has a connection portion 35 provided in the magnet hole 33 thereof. The connection portion 35 connects, at a bent portion of the substantially V-shape (i.e., at a radially inner end portion) of the magnet hole 33, the outer core portion 34 and a portion of the core sheet 24 which is formed around the shaft insertion hole 31. On the other hand, each of the second magnetic-pole forming parts 42 has no connection portion formed in the magnet hole 33 thereof.

### (Configuration of First Fitting Portions 43)

Each of the core sheets 24 has first fitting portions 43. The first fitting portions 43 are provided respectively in the outer core portions 34 of the first magnetic-pole forming parts 41. That is, in each of the core sheets 24, there are provided four first fitting portions 43.

As shown in FIG. 5, each of the first fitting portions 43 has a convex shape protruding in the axial direction. The first fitting portions 43 are formed by performing press working on the core sheet 24. On the back side of the first fitting portions 43, there are recesses 44 formed during the press forming of the first fitting portions 43. Specifically, for each of the core sheets 24, a punch (not shown) is pressed axially against a first surface of the core sheet 24, thereby forming the recesses 44 in the first surface and the first fitting portions 43 on a second surface of the core sheet 24 which is on an opposite side to the first surface. Consequently, the first fitting portions 43 and the recesses 44 have substantially the same shape as viewed in the axial direction. More particularly, in the present embodiment, the first fitting portions 43 and the recesses 44 are circular in shape in axial view. Moreover, every pair of the first fitting portions 43 and the recesses 44 are not offset from each other in the circumferential direction. That is, for each pair of the first fitting portions 43 and the recesses 44, a center 43a of the first fitting portion 43 and a center 44a of the recess 44 are located on a same straight line L2 along the axial direction.

### (Configuration of Second Fitting Portions 45)

As shown in FIG. 2, each of the core sheets 24 also has second fitting portions 45. The second fitting portions 45 are provided respectively in the outer core portions 34 of the second magnetic-pole forming parts 42. That is, in each of the core sheets 24, there are provided four second fitting portions 45. Moreover, in each of the core sheets 24, the first fitting portions 43 and the second fitting portions 45 are provided alternately in the circumferential direction to the eight magnetic-pole forming parts 32.

Each of the second fitting portions 45 has a concave shape recessed in the axial direction. Specifically, each of the second fitting portions 45 is formed as a through-hole that penetrates the core sheet 24 in the axial direction. The second fitting portions 45 are circular in shape in axial view. Moreover, all of the first fitting portions 43 and the second fitting portions 45 are located on a same circle centering on the central axis L1.

As described above, the first fitting portions 43 are provided respectively in the first magnetic-pole forming parts 41, whereas the second fitting portions 45 are provided respectively in the second magnetic-pole forming parts 42. That is, the first fitting portions 43 and the second fitting portions 45 provided in the same core sheet 24 are located at positions not overlapping each other in the axial direction.

### (Arrangement of First Fitting Portions 43 and Second Fitting Portions 45)

The pitch angle θ1 of the magnetic-pole forming parts 32 is the angle between the circumferential centers of each circumferentially-adjacent pair of the magnetic-pole forming parts 32. That is, the pitch angle θ1 of the magnetic-pole forming parts 32 is such that θ1=360°/P, where P is the number of poles of the rotor 20. Therefore, in the present embodiment, the pitch angle θ1 is equal to 45°. In addition, in the present embodiment, for each circumferentially-adjacent pair of the first and second magnetic-pole forming parts 41 and 42, the angle between the circumferential center C1 of the first magnetic-pole forming part 41 and the circumferential center C2 of the second magnetic-pole forming part 42 is equal to the pitch angle θ1, i.e., 45°.

The first fitting portions 43 are provided so that the centers 43a of the first fitting portions 43 are located respectively on the circumferential centers C1 of the first magnetic-pole forming parts 41. On the other hand, the second fitting portions 45 are provided so that the centers 45a of the second fitting portions 45 are located respectively at positions circumferentially offset by an offset angle θ2 respectively from the circumferential centers C2 of the second magnetic-pole forming parts 42.

In addition, each of the first fitting portions 43 is provided at the circumferential center of the outer core portion 34 of the corresponding first magnetic-pole forming part 41. Consequently, it becomes possible to form each of the first fitting portions 43 at a position away from the circumferential edges of the outer core portion 34 of the corresponding first magnetic-pole forming part 41, i.e., away from the circumferential inner edges of the magnet hole 33 of the corresponding first magnetic-pole forming part 41. As a result, it becomes possible to avoid decrease in the rigidity of the outer core portion 34 which would occur if the first fitting portion 43 is provided at a position close to either of the circumferential edges of the outer core portion 34.

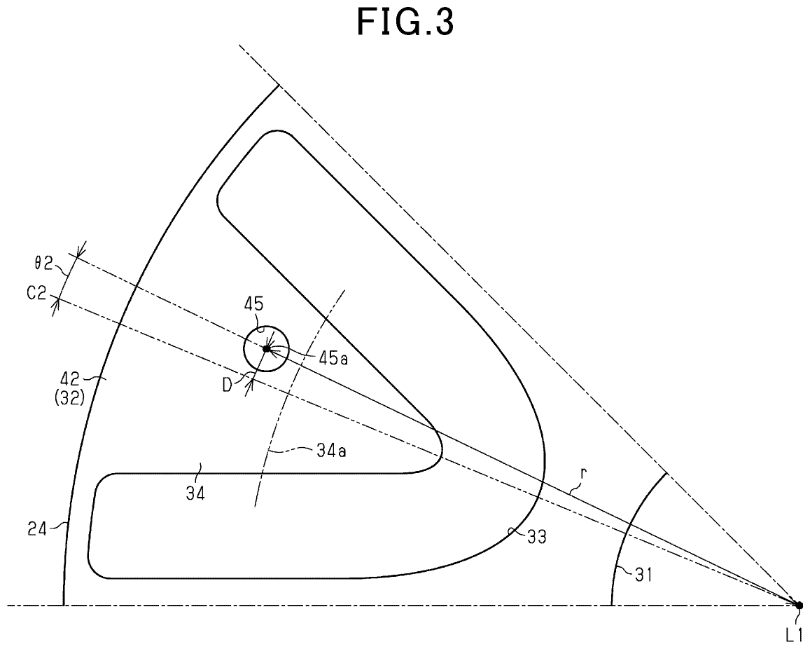

As shown in FIG. 3, for each of the second fitting portions 45, the offset distance D of the second fitting portion 45 from the circumferential center C2 of the corresponding second magnetic-pole forming part 42 is such that D≈r×sin(θ2), where r is the distance from the central axis L1 of the core sheet 24 to the center 45a of the second fitting portion 45. The offset distance D is set to a length greater than or equal to one tenth of the thickness t of the core sheet 24. That is, the distance r, the offset angle θ2 of the second fitting portion 45 and the thickness t of the core sheet 24 are set to satisfy the following relationship: 0.1t≤r×sin(θ2). Moreover, each of the second fitting portions 45 is provided so that the center 45a of the second fitting portion 45 is located radially outside the radial centerline 34a of the outer core portion 34 of the corresponding second magnetic-pole forming part 42.

As shown in FIG. 5, each axially-adjacent pair of the core sheets 24 laminated in the axial direction are joined together by fitting the first fitting portions 43 of one of the pair of the core sheets 24 respectively into the second fitting portions 45 of the other of the pair of the core sheets 24. Consequently, in the laminated state of the core sheets 24, the first magnetic-pole forming parts 41 and the second magnetic-pole forming parts 42 overlap one another alternately in the axial direction.

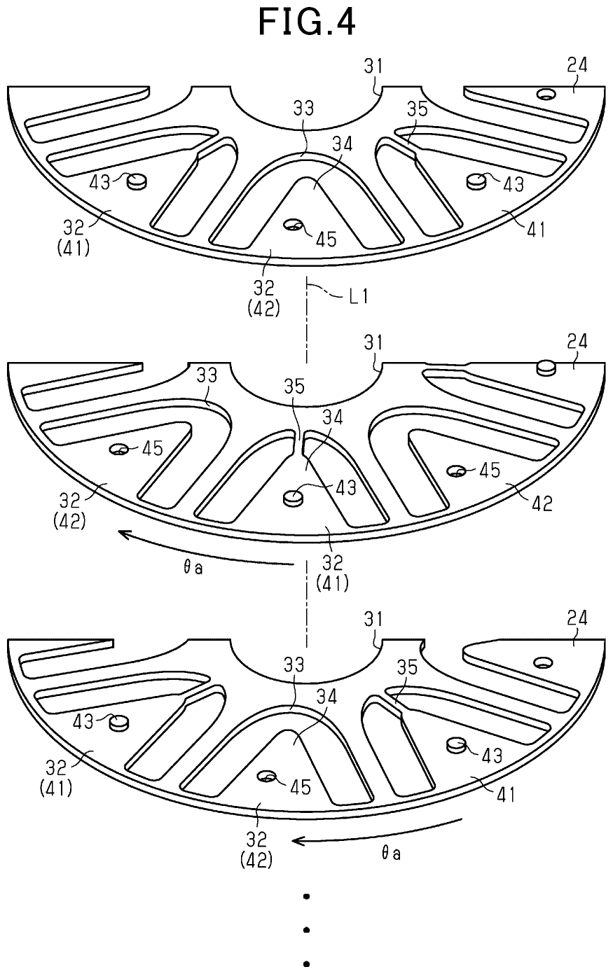

Moreover, as shown in FIG. 4, the core sheets 24 are laminated in a state of having been rotated by a rotational buildup angle θa about the central axis L1 in units of, for example, one core sheet 24. In the present embodiment, the rotational buildup angle θa is set such that θa=θ1+θ2. That is, each axially-adjacent pair of the core sheets 24 have been rotated relative to each other by an angle that is equal to the sum of the pitch angle θ1 of the magnetic-pole forming parts 32 and the offset angle θ2.

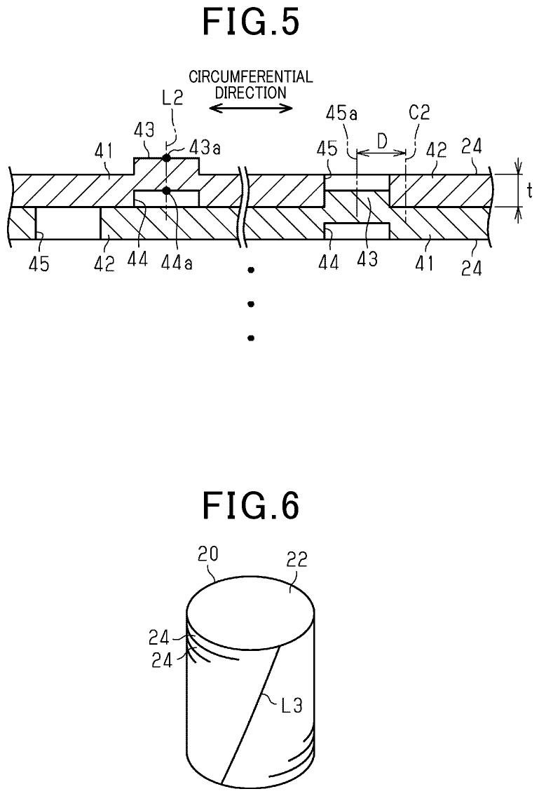

As described above, in the present embodiment, the core sheets 24 are joined to one another by fitting the first fitting portions 43 into the respective second fitting portions 45. Moreover, the centers 43a of the first fitting portions 43 are located respectively on the circumferential centers C1 of the first magnetic-pole forming parts 41, whereas the centers 45a of the second fitting portions 45 are offset by the offset angle θ2 respectively from the circumferential centers C2 of the second magnetic-pole forming parts 42. Consequently, the magnetic-pole forming parts 32 of the core sheets 24 are laminated in the axial direction in a state of having been circumferentially offset by the offset angle θ2 in units of one core sheet 24. That is, the magnetic poles of the rotor core 22 formed by the axially-laminated magnetic-pole forming parts 32 have a so-called skew structure in which the magnetic poles are circumferentially offset with change in the positions thereof in the axial direction from one axial end to the other axial end of the rotor core 22. FIG. 6 shows the rotor core 22 formed by laminating the core sheets 24 in the above-described manner. In FIG. 6, there is shown, on the outer circumferential surface of the rotor core 22, a skew line L3 tracing the circumferential centers (i.e., circumferential centers C1 and C2) of the magnetic-pole forming parts 32 of the core sheets 24 laminated in the axial direction. It should be noted that for the sake of simplicity, detailed shapes of the core sheets 24, such as the shapes of the magnet holes 33, are not shown in FIG. 6 and FIGS. 7 and 8 to be described later. As shown by the skew line L3, the magnetic-pole forming parts 32 laminated in the axial direction have a so-called skew structure in which they are circumferentially offset with change in the positions thereof in the axial direction from one axial end to the other axial end of the rotor core 22. The amount of circumferential offset of the skew structure is determined by the offset angle θ2 of the second fitting portions 45 and the number of the core sheets 24 laminated together.

The magnet holes 33 of the magnetic-pole forming parts 32 laminated in the axial direction are also circumferentially offset along the skew line L3 with change in the positions thereof in the axial direction from one axial end to the other axial end of the rotor core 22. Moreover, the permanent magnets 23 are provided in the accommodation spaces formed by the magnet holes 33 of the core sheets 24 which are connected together along the skew line L3.

In the present embodiment, the permanent magnets 23 are implemented by bonded magnets that are filled in the accommodation spaces formed by the magnet holes 33 of the core sheets 24 which are connected together along the skew line L3. Consequently, the permanent magnets 23 have a folded substantially V-shape that is convex radially inward as viewed in the axial direction. Moreover, the permanent magnets 23 are also circumferentially offset along the skew line L3 with change in the positions thereof in the axial direction from one axial end to the other axial end of the rotor core 22. In addition, in the present embodiment, a samarium-iron-nitrogen-based (i.e., SmFeN-based) magnet powder is employed as the magnet powder for forming the permanent magnets 23. It should be noted that other rare-earth magnet powders may alternatively be employed as the magnet powder for forming the permanent magnets 23. The magnetic poles of the rotor 20 are formed by the magnetic-pole forming parts 32 laminated in the axial direction and the permanent magnets 23 provided in the accommodation spaces formed by the magnet holes 33 of the magnetic-pole forming parts 32.

Next, operation of the rotating electric machine M according to the present embodiment will be described. In the present embodiment, the magnetic poles of the rotor core 22 have the skew structure in which they are circumferentially offset with change in the positions thereof in the axial direction from one axial end to the other axial end of the rotor core 22. Consequently, it becomes possible to minimize cogging torque generated in the rotating electric machine M.

Next, advantageous effects achievable according to the present embodiment will be described.

(1) In the present embodiment, each axially-adjacent pair of the core sheets 24 laminated in the axial direction are joined together by fitting the first fitting portions 43 of one of the pair of the core sheets 24 respectively into the second fitting portions 45 of the other of the pair of the core sheets 24. Moreover, the first fitting portions 43 and the second fitting portions 45 provided in the same core sheet 24 are located at positions not overlapping each other in the axial direction.

In contrast, in a comparative example, each axially-adjacent pair of the core sheets 24 are joined together by fitting the first fitting portions 43 of one of the pair of the core sheets 24 respectively into the recesses 44 formed on the back side of the first fitting portions 43 in the other of the pair of the core sheets 24. In the comparative example, to realize a skew structure of the magnetic poles of the rotor 20, it is necessary to circumferentially offset the first fitting portions 43 from the recesses 44 on the back side of the first fitting portions 43. Moreover, it is possible to make the first fitting portions 43 and the recesses 44 on the back side thereof offset in the circumferential direction by shifting a die and a punch, which are used in the press working for forming the first fitting portions 43, in the circumferential direction. However, in the press working, it is difficult to make the amount of circumferential offset between the first fitting portions 43 and the recesses 44 large. Consequently, constraints will be imposed on the design of the rotor core 22, such as the necessity of increasing the axial length of the rotor core 22 for securing a desired amount of circumferential offset of the skew structure.

In this regard, in the present embodiment, in each of the core sheets 24, the first fitting portions 43 and the second fitting portions 45 are provided at positions not overlapping each other in the axial direction. In other words, the first fitting portions 43 are not involved in the forming of the second fitting portions 45. Therefore, the degree of freedom in setting the formation positions of the second fitting portions 45 is high. Consequently, it becomes possible to secure a large offset angle θ2 of the second fitting portions 45. As a result, it becomes possible to easily secure the amount of circumferential offset of the skew structure, thereby alleviating constraints on the design of the rotor core 22.

(2) In the present embodiment, in each of the core sheets 24, the magnetic-pole forming parts 32 include the first magnetic-pole forming parts 41 in which the first fitting portions 43 are respectively provided, and the second magnetic-pole forming parts 42 in which the second fitting portions 45 are respectively provided. The centers 43a of the first fitting portions 43 are set respectively on the circumferential centers C1 of the first magnetic-pole forming parts 41. On the other hand, the centers 45a of the second fitting portions 45 are set respectively to the positions circumferentially offset by the offset angle θ2 respectively from the circumferential centers C2 of the second magnetic-pole forming parts 42. With the above configuration, it becomes possible to realize, by fitting the first fitting portions 43 and the second fitting portions 45 of each axially-adjacent pair of the core sheets 24 to each other, the skew structure of the magnetic poles of the rotor 20 which are formed by the axially-laminated magnetic-pole forming parts 32.

(3) In the present embodiment, each of the core sheets 24 is configured to satisfy the following relationship: 0.1t≤r×sin(θ2), where t is the thickness of the core sheet 24, r is the distance from the central axis L1 of the core sheet 24 to each of the centers 45a of the second fitting portions 45, and θ2 is the offset angle of each of the second fitting portions 45. With the above configuration, it becomes possible to improve the degree of freedom in setting the formation positions of the second fitting portions 45, thereby making it easy to set the circumferential offset distance D (D≈r×sin(θ2)) of each of the second fitting portions 45 to be greater than or equal to one tenth of the thickness t of the core sheet 24. Consequently, it becomes possible to eliminate constraints on the design of the rotor core 22 which include, for example, the necessity of reducing the distance r from the central axis L1 of the core sheet 24 to each of the centers 45a of the second fitting portions 45 for securing the offset angle θ2 of each of the second fitting portions 45.

(4) In the present embodiment, the core sheets 24 are laminated in a state of having been rotated by the rotational buildup angle θa in units of one core sheet 24. Moreover, the rotational buildup angle θa is set such that θa=θ1+θ2, where θ1 is the pitch angle of the magnetic-pole forming parts 32 in each of the core sheets 24, and θ2 is the offset angle of each of the second fitting portions 45 of the core sheets 24. With the above configuration, it becomes possible to laminate the core sheets 24 in a state of having each axially-adjacent pair of the core sheets 24 rotated relative to each other by the angle θa that is equal to the sum of the pitch angle θ1 of the magnetic-pole forming parts 32 and the offset angle θ2.

(5) In the present embodiment, in each of the core sheets 24, the magnetic-pole forming parts 32 consist of the first magnetic-pole forming parts 41 in which the first fitting portions 43 are respectively provided and the second magnetic-pole forming parts 42 in which the second fitting portions 45 are respectively provided; and the first magnetic-pole forming parts 41 and the second magnetic-pole forming parts 42 are arranged alternately in the circumferential direction. With the above configuration, it becomes possible to provide the first fitting portions 43 and the second fitting portions 45 alternately in the circumferential direction to the magnetic-pole forming parts 32. Consequently, it becomes possible to secure the number of the locations of fitting between the first fitting portions 43 and the second fitting portions 45 in each axially-adjacent pair of the core sheets 24 to be half the number of the magnetic-pole forming parts 32 in each of the core sheets 24.

(6) In the present embodiment, each of the first fitting portions 43 has a convex shape protruding in the axial direction, whereas each of the second fitting portions 45 is a through-hole that penetrates the core sheet 24 in the axial direction. The second fitting portions 45, each of which is a through-hole, have higher magnetic reluctance than the first fitting portions 43. Therefore, by circumferentially offsetting the second fitting portions 45 respectively from the circumferential centers C2 of the second magnetic-pole forming parts 42 where the magnetic flux density is high, it becomes possible to minimize the adverse effect of the second fitting portions 45 on the magnetic characteristics of the rotor core 22.

(7) In the present embodiment, all of the offset angles θ2 of the second fitting portions 45 of the core sheets 24 are equal to each other. With this configuration, it becomes possible to have all the core sheets 24 formed in the same shape.

(8) In the present embodiment, each of the second fitting portions 45 is a through-hole that penetrates the core sheet 24 in the axial direction. With this configuration, it becomes possible to easily form the second fitting portions 45 into which the convex first fitting portions 43 are respectively fitted.

(9) Each of the core sheets 24 has the recesses 44 formed on the back side of the first fitting portions 43 during the press forming of the first fitting portions 43. Moreover, for each pair of the first fitting portions 43 and the recesses 44, the center 43a of the first fitting portion 43 and the center 44a of the recess 44 are located on the same straight line L2 along the axial direction. With the above configuration, it becomes possible to accurately form the convex shape of the first fitting portions 43 by press working.

(10) In the present embodiment, in each of the core sheets 24, each of the magnetic-pole forming parts 32 has a magnet hole 33 in which a permanent magnet 23 is provided. The magnet hole 33 has a folded shape that is convex radially inward as viewed in the axial direction. With this configuration, it becomes possible to secure the size of the outer core portions 34 of the magnetic-pole forming parts 32 which contribute to the reluctance torque.

(11) In the present embodiment, in each of the core sheets 24, each of the magnetic-pole forming parts 32 has an outer core portion 34 on the radially outer side of the magnet hole 33. Each of the first fitting portions 43 and the second fitting portions 45 is provided in a corresponding one of the outer core portions 34 of the magnetic-pole forming parts 32. With the above configuration, in each of the magnetic-pole forming parts 32, the area of the outer core portion 34 can be secured by forming the magnet hole 33 into the substantially V-shape. Hence, by setting the formation positions of the first fitting portions 43 and the second fitting portions 45 to be in the corresponding outer core portions 34, it becomes possible to improve the degree of freedom in setting the formation positions of the first fitting portions 43 and the second fitting portions 45.

(12) In the present embodiment, in each of the second magnetic-pole forming parts 42, the second fitting portion 45 is provided so that the center 45a of the second fitting portion 45 is located radially outside the radial centerline 34a of the outer core portion 34. When the formation position of the second fitting portion 45 is deviated from a desired position in the circumferential direction due to manufacturing tolerances, the more the second fitting portion 45 is located radially inward (i.e., the shorter the distance r is), the larger the deviation of the offset angle θ2 of the second fitting portion 45 from a desired angle is. Therefore, with the center 45a of the second fitting portion 45 located radially outside the radial centerline 34a of the outer core portion 34, it becomes possible to minimize the deviation of the offset angle θ2.

(13) In the present embodiment, each of the first fitting portions 43 has a circular shape as viewed in the axial direction. Consequently, it becomes possible to achieve a uniform distribution of stress around each of the first fitting portions 43. Similarly, each of the second fitting portions 45 also has a circular shape as viewed in the axial direction. Consequently, it becomes possible to achieve a uniform distribution of stress around each of the second fitting portions 45.

(14) In the present embodiment, in each of the magnetic-pole forming parts 32, there is provided only one first fitting portion 43 or one second fitting portion 45. The first fitting portions 43 and the second fitting portions 45 are factors that impede the flow of magnetic flux in the magnetic-pole forming parts 32. Therefore, by minimizing the number of the first fitting portions 43 or second fitting portions 45 provided in each of the magnetic-pole forming parts 32, it becomes possible to minimize the adverse effects of the first fitting portions 43 and the second fitting portions 45 on the flow of magnetic flux in the magnetic-pole forming parts 32.

The present embodiment can be modified and implemented as follows. Moreover, the present embodiment and the following modifications can also be implemented in combination with each other to the extent that there is no technical contradiction between them.

The core sheets 24 that together form the rotor core 22 may include core sheets 24 having different offset angles θ2 of the second fitting portions 45.

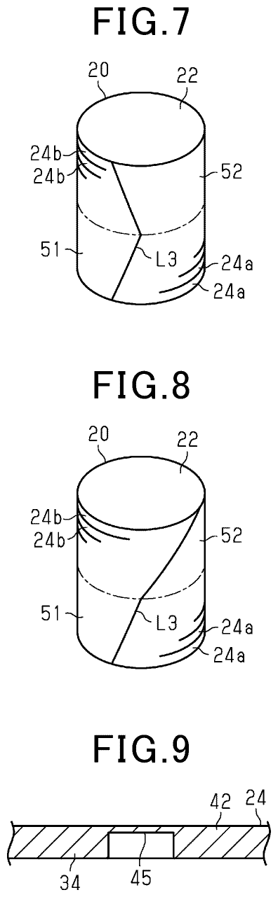

For example, in a rotor core 22 shown in FIG. 7, a first core sheet group 51 and a second core sheet group 52 are overlapped in the axial direction. The first core sheet group 51 is constituted of a plurality of core sheets 24 having the same shape and laminated in the axial direction. The core sheets 24 constituting the first core sheet group 51 will be referred to as the first core sheets 24a hereinafter. The first core sheets 24a are identical in shape to each other. On the other hand, a plurality of core sheets 24 constituting the second core sheet group 52 will be referred to as the second core sheets 24b hereinafter. The second core sheets 24b are also identical in shape to each other.

Moreover, the offset angle θ2 of each of the second fitting portions 45 in the first core sheets 24a is set to α°, whereas the offset angle θ2 of each of the second fitting portions 45 in the second core sheets 24b is set to B°. In the example shown in FIG. 7, a has a positive value, whereas β has a negative value. That is, the second fitting portions 45 of the second core sheets 24b are offset in the opposite direction to the second fitting portions 45 of the first core sheets 24a. Consequently, in the skew structure of the magnetic poles of the rotor 20, it becomes possible to have the circumferential offset toward one axial side made in opposite directions in the first core sheet group 51 and the second core sheet group 52. Thus, it becomes possible to have the axial thrust force, which is generated due to the skew structure of the magnetic poles of the rotor 20, acting in opposite directions in the first core sheet group 51 and the second core sheet group 52. As a result, it becomes possible to reduce the total axial thrust force of the rotor 20 which is the sum of the axial thrust forces generated by the first core sheet group 51 and the second core sheet group 52.

Moreover, in the example shown in FIG. 7, the absolute value of a that has a positive value and the absolute value of β that has a negative value are set to be equal to each other. Consequently, in the skew structure of the magnetic poles of the rotor 20, it becomes possible to have the amount of circumferential offset equal for the first core sheet group 51 and the second core sheet group 52. Thus, it becomes possible to have the axial thrust forces, which are generated respectively in the first core sheet group 51 and the second core sheet group 52, cancelling each other out. As result, it becomes possible to minimize the total axial thrust force of the rotor 20. In addition, in FIG. 8, there is shown an example where β also has a positive value and α<β.

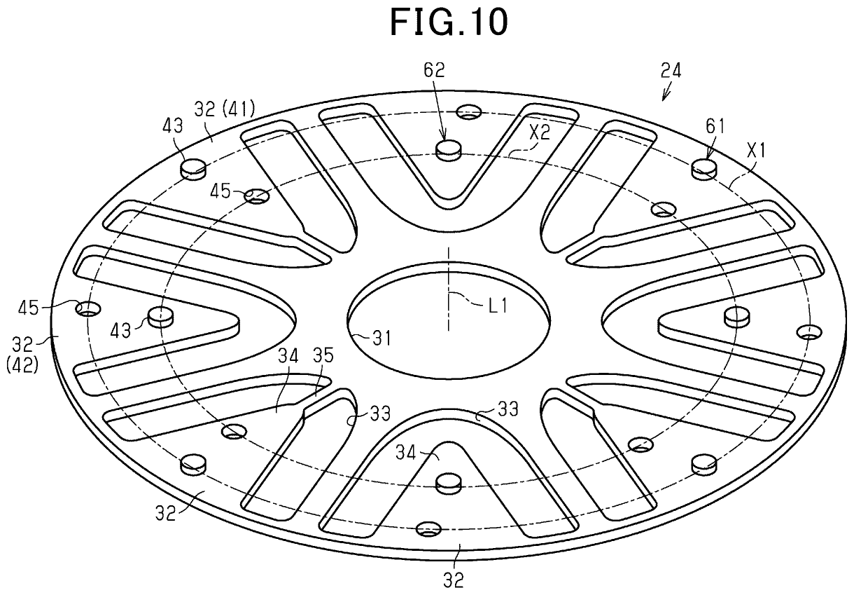

As shown in FIG. 9, each of the second fitting portions 45 may alternatively be formed as a recess that does not penetrate the core sheet 24. With this configuration, it will become possible to lower the magnetic reluctance of each of the second fitting portions 45 in comparison with the case where each of the second fitting portions 45 is a through-hole.

In the above-described embodiment, in each of the core sheets 24, there is provided only one concave-convex group consisting of the first fitting portions 43 and the second fitting portions 45 all of which are arranged on the same circle centering on the central axis L1. However, the present disclosure is not limited to this configuration; and two or more concave-convex groups may be provided in each of the core sheets 24.

FIG. 10 shows an example where each of the core sheets 24 has: a first concave-convex group 61 consisting of a plurality of first fitting portions 43 and a plurality of second fitting portions 45 all of which are arranged on a first reference circle X1 centering on the central axis L1 of the core sheet 24; and a second concave-convex group 62 consisting of a plurality of first fitting portions 43 and a plurality of second fitting portions 45 all of which are arranged on a second reference circle X2 centering on the central axis L1 and having a smaller diameter than the first reference circle X1.

In the first concave-convex group 61, the first fitting portions 43 and the second fitting portions 45 are provided alternately in the circumferential direction to the magnetic-pole forming parts 32. Similarly, in the second concave-convex group 62, the first fitting portions 43 and the second fitting portions 45 are also provided alternately in the circumferential direction to the magnetic-pole forming parts 32. Hereinafter, those of the magnetic-pole forming part 32 in which the first fitting portions 43 of the first concave-convex group 61 are respectively provided will be referred to as the first magnetic-pole forming parts 41; and those of the magnetic-pole forming part 32 in which the second fitting portions 45 of the first concave-convex group 61 are respectively provided will be referred to as the second magnetic-pole forming parts 42. In each of the first magnetic-pole forming parts 41, there are provided one of the first fitting portions 43 of the first concave-convex group 61 and one of the second fitting portions 45 of the second concave-convex group 62. On the other hand, in each of the second magnetic-pole forming parts 42, there are provided one of the second fitting portions 45 of the first concave-convex group 61 and one of the first fitting portions 43 of the second concave-convex group 62. Moreover, the first fitting portions 43 of the first and second concave-convex groups 61 and 62 are provided respectively at the circumferential centers of the magnetic-pole forming parts 32. On the other hand, the second fitting portions 45 of the first and second concave-convex groups 61 and 62 are provided respectively at positions circumferentially offset respectively from the circumferential centers of the magnetic-pole forming parts 32.

In each of the first concave-convex group 61 and the second concave-convex group 62, the first fitting portions 43 and the second fitting portions 45 in the same concave-convex group correspond to each other. That is, when the core sheets 24 are laminated, for each axially-adjacent pair of the core sheets 24, the first fitting portions 43 of the first concave-convex group 61 of one of the pair of the core sheets 24 are fitted respectively into the second fitting portions 45 of the first concave-convex group 61 of the other of the pair of the core sheets 24. Moreover, for each axially-adjacent pair of the core sheets 24, the first fitting portions 43 of the second concave-convex group 62 of one of the pair of the core sheets 24 are fitted respectively into the second fitting portions 45 of the second concave-convex group 62 of the other of the pair of the core sheets 24.

With the configuration shown in FIG. 10, it becomes possible to improve, by the first concave-convex group 61 and the second concave-convex group 62, the joining strength between the core sheets 24 laminated in the axial direction. Moreover, the first reference circle X1 and the second reference circle X2, which respectively serve as the references for the positions of the first fitting portions 43 and the second fitting portions 45 in the first concave-convex group 61 and the second concave-convex group 62, have different diameters. Consequently, in each of the magnetic-pole forming parts 32, the first fitting portion 43 and the second fitting portion 45 are not aligned with each other in the circumferential direction. As a result, it becomes possible to avoid decrease in the rigidity of the outer core portion 34 which would occur if the first fitting portion 43 and the second fitting portion 45 are provided at positions close to the circumferential edges of the outer core portion 34.

Moreover, with the above configuration, each of the magnetic-pole forming parts 32 has only one first fitting portion 43 and one second fitting portion 45 provided therein. That is, none of the magnetic-pole forming parts 32 has the second fitting portions 45 of both the first and second concave-convex groups 61 and 62 provided therein. Consequently, it becomes possible to prevent each of the magnetic-pole forming parts 32 from having a plurality of second fitting portions 45 provided therein; the magnetic reluctance of the second fitting portions 45 are higher than that of the first fitting portions 43. As a result, it becomes possible to suppress increase in the magnetic reluctance in each of the magnetic-pole forming parts 32.

In the configuration shown in FIG. 10, each of the first magnetic-pole forming parts 41 may alternatively have one first fitting portion 43 of the first concave-convex group 61 and one first fitting portion 43 of the second concave-convex group 62 provided therein; and each of the second magnetic-pole forming parts 42 may alternatively have one second fitting portion 45 of the first concave-convex group 61 and one second fitting portion 45 of the second concave-convex group 62 provided therein. Moreover, in the configuration shown in FIG. 10, each of the core sheets 24 has only two concave-convex groups (i.e., the first concave-convex group 61 and the second concave-convex group 62) provided therein. However, the present disclosure is not limited to this configuration; and each of the core sheets 24 may have three or more concave-convex groups provided therein. In addition, in the case of each of the core sheets 24 having three or more concave-convex groups provided therein, the dimeters of reference circles, which respectively serve as the references for the arrangements of the concave-convex groups, are set to be different from each other.

In the above-described embodiment, in each of the core sheets 24, the centers 43a and 45a of the first and second fitting portions 43 and 45 may alternatively be set to positions radially inside the radial centerlines 34a of the outer core portions 34 of the respective magnetic-pole forming parts 32.

In the above-described embodiment, the rotational buildup angle θa is not limited to (θa=θ1+θ2), but may be changed as appropriate. Specifically, in the above-described embodiment, the rotational buildup angle θa may be set such that θa=(θ1×(2N−1))+θ2, where N is an integer greater than or equal to 1.

In the above-described embodiment, the core sheets 24 may alternatively be laminated in a state of having been rotated by the rotational buildup angle θa in units of plural core sheets 24. In this case, each axially-adjacent pair of the core sheets 24 which are laminated together without being rotated relative to each other may be joined together by fitting the first fitting portions 43 of one of the pair of the core sheets 24 respectively into the recesses 44 of the other of the pair of the core sheets 24.

In the above-described embodiment, in each of the core sheets 24, the first fitting portions 43 and the second fitting portions 45 are arranged alternately in the circumferential direction with respect to the magnetic-pole forming parts 32. However, the present disclosure is not limited to this configuration. For example, a configuration may alternatively be employed where: a plurality of first fitting portions 43 are arranged continuously in the circumferential direction; and a plurality of second fitting portions 45 are arranged continuously in the circumferential direction. Moreover, it is not necessary to provide a first fitting portion 43 or a second fitting portion 45 in each of all the magnetic-pole forming parts 32. For example, the first fitting portions 43 and the second fitting portions 45 may be provided alternately to every other magnetic-pole forming part 32 in the circumferential direction. In addition, depending on the arrangement of the first fitting portions 43 and the second fitting portions 45, the rotational buildup angle θa may be set such that θa=(θ1×N)+θ2, where N is an integer greater than or equal to 1.

In the above-described embodiment, the centers 43a of the first fitting portions 43 may alternatively be set respectively to positions circumferentially offset from the circumferential centers C1 of the first magnetic-pole forming parts 41. In addition, in this case, it is necessary to set the offset angle of each of the first fitting portions 43 to be different from the offset angle θ2 of each of the second fitting portions 45. With this configuration, it will become possible to improve the degree of freedom in the arrangement of the first fitting portions 43.

In the above-described embodiment and in the example shown in FIG. 10, the concave-convex relationship between the first fitting portions 43 and the second fitting portions 45 in each of the core sheets 24 may be reversed. That is, each of the first fitting portions 43 may alternatively have a concave shape recessed in the axial direction; and each of the second fitting portions 45 may alternatively have a convex shape protruding in the axial direction.

The number of poles of the rotor 20, i.e., the number of the magnetic-pole forming parts 32 in each of the core sheets 24, is not limited to eight as in the above-described embodiment, but may alternatively be set to seven or less, or nine or more.

The shape of the magnet holes 33 in axial view is not limited to that in the above-described embodiment, but may alternatively be any other folded shape that is convex radially inward, such as a U-shape. Moreover, the magnet holes 33 may alternatively have shapes other than folded shapes, such as an I-shape.

The first fitting portions 43 and the second fitting portions 45 in the above-described embodiment may be applied to core sheets forming the stator core 11.

While the present disclosure has been described pursuant to the embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

### (Notes)

The features of the present disclosure are as follows.

[1] A core (22) for a rotating electric machine, the core being formed by laminating a plurality of core sheets (24) in an axial direction, each of the core sheets having a plurality of magnetic-pole forming parts (32) provided at equal intervals in a circumferential direction, wherein: each of the core sheets has a first fitting portion (43) and a second fitting portion (45); one of the first fitting portion and the second fitting portion has a convex shape protruding in the axial direction; the other of the first fitting portion and the second fitting portion has a concave shape recessed in the axial direction; an axially-adjacent pair of the core sheets are joined together by fitting the first fitting portion of one of the pair of the core sheets and the second fitting portion of the other of the pair of the core sheets to each other; and the first fitting portion and the second fitting portion provided in a same one of the core sheets are located at positions not overlapping each other in the axial direction.

[2] The core for a rotating electric machine as set forth in the above note [1], wherein: in each of the core sheets; the plurality of magnetic-pole forming parts include a first magnetic-pole forming part (41) having the first fitting portion provided therein; and a second magnetic-pole forming part (42) having the second fitting portion provided therein; a center (43a) of the first fitting portion is set on a circumferential center (C1) of the first magnetic-pole forming part; and a center (45a) of the second fitting portion is set to a position circumferentially offset from a circumferential center (C2) of the second magnetic-pole forming part.

[3] The core for a rotating electric machine as set forth in the above note [1], wherein: in each of the core sheets; the plurality of magnetic-pole forming parts include a first magnetic-pole forming part (41) having the first fitting portion provided therein; and a second magnetic-pole forming part (42) having the second fitting portion provided therein; a center (43a) of the first fitting portion is set to a position circumferentially offset from a circumferential center (C1) of the first magnetic-pole forming part; and a center (45a) of the second fitting portion is set to a position circumferentially offset from a circumferential center (C2) of the second magnetic-pole forming part.

[4] The core for a rotating electric machine as set forth in the above note [2], wherein each of the core sheets is configured to satisfy the following relationship: 0.1t≤r×sin(θ2), where t is a thickness of the core sheet, r is a distance from a central axis (L1) of the core sheet to the center of the second fitting portion, and θ2 is an offset angle of the second fitting portion.

[5] The core for a rotating electric machine as set forth in the above note [2] or [4], wherein: the core sheets are laminated in a state of having been rotated by a rotational buildup angle α in units of one core sheet or in units of plural core sheets; and the rotational buildup angle θa is set such that θa=(θ1×N)+θ2, where θ1 is a pitch angle of the magnetic-pole forming parts in each of the core sheets, θ2 is an offset angle of the second fitting portion in each of the core sheets, and N is an integer greater than or equal to 1.

[6] The core for a rotating electric machine as set forth in any one of the above notes [2] to [5], wherein in each of the core sheets, the plurality of magnetic-pole forming parts consist of a plurality of first magnetic-pole forming parts and a plurality of second magnetic-pole forming parts which are arranged alternately in the circumferential direction.

[7] The core for a rotating electric machine as set forth in any one of the above notes [2] to [6], wherein: the first fitting portion has the convex shape protruding in the axial direction; and the second fitting portion is a through-hole (45) that penetrates the core sheet in the axial direction.

[8] The core for a rotating electric machine as set forth in any one of the above notes [2] to [7], wherein all of offset angles (θ2) of the second fitting portions of the core sheets are equal to each other.

[9] The core for a rotating electric machine as set forth in any one of the above notes [2] to [7], wherein the plurality of core sheets include core sheets having different offset angles (θ2) of the second fitting portions.

[10] The core for a rotating electric machine as set forth in any one of the above notes [1] to [9], wherein the other of the first fitting portion and the second fitting portion, which has the concave shape recessed in the axial direction, is a through-hole (45) that penetrates the core sheet in the axial direction.

[11] The core for a rotating electric machine as set forth in any one of the above notes [1] to [10], wherein: the first fitting portion has the convex shape protruding in the axial direction; the second fitting portion has the concave shape recessed in the axial direction; each of the core sheets has a recess (44) formed on a back side of the first fitting portion during press forming of the first fitting portion; and a center (43a) of the first fitting portion and a center (44a) of the recess are located on a same straight line (L2) along the axial direction.

[12] The core for a rotating electric machine as set forth in any one of the above notes [1] to [11], wherein: the core is a rotor core (22) for a rotor (20) of a rotating electric machine (M); in each of the core sheets, each of the magnetic-pole forming parts has a magnet hole (33) in which a permanent magnet (23) is provided; and the magnet hole has a folded shape that is convex radially inward as viewed in the axial direction.

[13] The core for a rotating electric machine as set forth in the above note [12], wherein: in each of the core sheets, each of the magnetic-pole forming parts has an outer core portion (34) on a radially outer side of the magnet hole; and each of the first fitting portion and the second fitting portion is provided in a corresponding one of the outer core portions of the magnetic-pole forming parts.

[14] The core for a rotating electric machine as set forth in any one of the above notes [1] to [13], wherein each of the core sheets has: a first concave-convex group (61) including the first fitting portion and the second fitting portion both of which are arranged on a first reference circle (X1) centering on a central axis (L1) of the core sheet; and a second concave-convex group (62) including a first fitting portion and a second fitting portion both of which are arranged on a second reference circle (X2) centering on the central axis of the core sheet and having a smaller diameter than the first reference circle.

A rotating electric machine (M) comprising a rotor (20) having a rotor core (22) and a stator (10) having a stator core (11), wherein: at least one of the rotor core and the stator core is formed by laminating a plurality of core sheets (24) in an axial direction, each of the core sheets having a plurality of magnetic-pole forming parts (32) provided at equal intervals in a circumferential direction; each of the core sheets has a first fitting portion (43) and a second fitting portion (45); one of the first fitting portion and the second fitting portion has a convex shape protruding in the axial direction; the other of the first fitting portion and the second fitting portion has a concave shape recessed in the axial direction; an axially-adjacent pair of the core sheets are joined together by fitting the first fitting portion of one of the pair of the core sheets and the second fitting portion of the other of the pair of the core sheets to each other; and the first fitting portion and the second fitting portion provided in a same one of the core sheets are located at positions not overlapping each other in the axial direction.

1. A core for a rotating electric machine, the core being formed by laminating a plurality of core sheets in an axial direction, each of the core sheets having a plurality of magnetic-pole forming parts provided at equal intervals in a circumferential direction,
wherein
each of the core sheets has:
a first fitting-portion group including a first fitting portion and a second fitting portion both of which are arranged on a first reference circle centering on a central axis of the core sheet; and
a second fitting-portion group including a first fitting portion and a second fitting portion both of which are arranged on a second reference circle centering on the central axis of the core sheet and having a smaller diameter than the first reference circle,
in each of the first and second fitting-portion groups:
one of the first and second fitting portions has a convex shape protruding in the axial direction;
the other of the first and second fitting portions has a concave shape recessed in the axial direction; and
the first and second fitting portions are located at positions not overlapping each other in the axial direction,
in each of the core sheets, the plurality of magnetic-pole forming parts include:
a first magnetic-pole forming part in which both the first fitting portion of the first fitting-portion group and the second fitting portion of the second fitting-portion group are provided; and
a second magnetic-pole forming part in which both the second fitting portion of the first fitting-portion group and the first fitting portion of the second fitting-portion group are provided,
an axially-adjacent pair of the core sheets are joined together with:
the first fitting portion of the first fitting-portion group of one of the pair of the core sheets and the second fitting portion of the first fitting-portion group of the other of the pair of the core sheets fitted to each other; and
the first fitting portion of the second fitting-portion group of one of the pair of the core sheets and the second fitting portion of the second fitting-portion group of the other of the pair of the core sheets fitted to each other.

2. The core for a rotating electric machine as set forth in claim 1, wherein in each of the core sheets:
a center of the first fitting portion of the first fitting-portion group is set on a circumferential center of the first magnetic-pole forming part;
a center of the second fitting portion of the first fitting-portion group is set to a position circumferentially offset from a circumferential center of the second magnetic-pole forming part;
a center of the first fitting portion of the second fitting-portion group is set on the circumferential center of the second magnetic-pole forming part; and
a center of the second fitting portion of the second fitting-portion group is set to a position circumferentially offset from the circumferential center of the first magnetic-pole forming part.

3. The core for a rotating electric machine as set forth in claim 1, wherein in each of the core sheets:
a center of the first fitting portion of the first fitting-portion group is set to a position circumferentially offset from a circumferential center of the first magnetic-pole forming part;
a center of the second fitting portion of the first fitting-portion group is set to a position circumferentially offset from a circumferential center of the second magnetic-pole forming part;
a center of the first fitting portion of the second fitting-portion group is set to a position circumferentially offset from the circumferential center of the second magnetic-pole forming part; and
a center of the second fitting portion of the second fitting-portion group is set to a position circumferentially offset from the circumferential center of the first magnetic-pole forming part.

4. The core for a rotating electric machine as set forth in claim 2, wherein each of the core sheets is configured to satisfy the following relationship:
$$0.1 t \leq r \times sin ( θ 2 ) ,$$
where t is a thickness of the core sheet, r is a distance from the central axis of the core sheet to the center of the second fitting portion of one of the first and second fitting-portion groups, and θ2 is an offset angle of the second fitting portion of the one of the first and second fitting-portion groups.

5. The core for a rotating electric machine as set forth in claim 2, wherein the core sheets are laminated in a state of having been rotated by a rotational buildup angle θa in units of one core sheet or in units of plural core sheets, and
the rotational buildup angle θa is set such that θa=(θ1×N)+θ2, where θ1 is a pitch angle of the magnetic-pole forming parts in each of the core sheets, θ2 is an offset angle of the second fitting portion of one of the first and second fitting-portion groups, and N is an integer greater than or equal to 1.

6. The core for a rotating electric machine as set forth in claim 2, wherein in each of the core sheets, the plurality of magnetic-pole forming parts consist of a plurality of the first magnetic-pole forming parts and a plurality of the second magnetic-pole forming parts, and
the plurality of first magnetic-pole forming parts and the plurality of second magnetic-pole forming parts are arranged alternately in the circumferential direction.

7. The core for a rotating electric machine as set forth in claim 2, wherein in each of the first and second fitting-portion groups:
the first fitting portion has the convex shape protruding in the axial direction; and
the second fitting portion is a through-hole that penetrates the core sheet in the axial direction.

8. The core for a rotating electric machine as set forth in claim 2, wherein all of offset angles of the second fitting portions of the core sheets are equal to each other.

9. The core for a rotating electric machine as set forth in claim 2, wherein the plurality of core sheets include core sheets having different offset angles of the second fitting portions.

10. The core for a rotating electric machine as set forth in claim 1, wherein in each of the first and second fitting-portion groups, the other of the first fitting portion and the second fitting portion, which has the concave shape recessed in the axial direction, is a through-hole that penetrates the core sheet in the axial direction.

11. The core for a rotating electric machine as set forth in claim 1, wherein in each of the first and second fitting-portion groups:
the first fitting portion has the convex shape protruding in the axial direction; and
the second fitting portion has the concave shape recessed in the axial direction,
for each of the first fitting portions of the first and second fitting-portion groups:
a recess is formed on a back side of the first fitting portion in the core sheet during press forming of the first fitting portion; and
a center of the first fitting portion and a center of the recess are located on a same straight line along the axial direction.

12. The core for a rotating electric machine as set forth in claim 1, wherein the core is a rotor core for a rotor of a rotating electric machine,
in each of the core sheets, each of the magnetic-pole forming parts has a magnet hole in which a permanent magnet is provided, and
the magnet hole has a folded shape that is convex radially inward as viewed in the axial direction.

13. The core for a rotating electric machine as set forth in claim 12, wherein in each of the core sheets, each of the magnetic-pole forming parts has an outer core portion on a radially outer side of the magnet hole,
both the first fitting portion of the first fitting-portion group and the second fitting portion of the second fitting-portion group are provided in the outer core portion of the first magnetic-pole forming part, and
both the second fitting portion of the first fitting-portion group and the first fitting portion of the second fitting-portion group are provided in the outer core portion of the second magnetic-pole forming part.

14. A rotating electric machine comprising:
a rotor having a rotor core; and
a stator having a stator core,
wherein
at least one of the rotor core and the stator core is formed by laminating a plurality of core sheets in an axial direction, each of the core sheets having a plurality of magnetic-pole forming parts provided at equal intervals in a circumferential direction,
each of the core sheets has:
a first fitting-portion group including a first fitting portion and a second fitting portion both of which are arranged on a first reference circle centering on a central axis of the core sheet; and
a second fitting-portion group including a first fitting portion and a second fitting portion both of which are arranged on a second reference circle centering on the central axis of the core sheet and having a smaller diameter than the first reference circle,
in each of the first and second fitting-portion groups:
one of the first and second fitting portions has a convex shape protruding in the axial direction;
the other of the first and second fitting portions has a concave shape recessed in the axial direction; and
the first and second fitting portions are located at positions not overlapping each other in the axial direction,
in each of the core sheets, the plurality of magnetic-pole forming parts include:
a first magnetic-pole forming part in which both the first fitting portion of the first fitting-portion group and the second fitting portion of the second fitting-portion group are provided; and
a second magnetic-pole forming part in which both the second fitting portion of the first fitting-portion group and the first fitting portion of the second fitting-portion group are provided,
an axially-adjacent pair of the core sheets are joined together with:
the first fitting portion of the first fitting-portion group of one of the pair of the core sheets and the second fitting portion of the first fitting-portion group of the other of the pair of the core sheets fitted to each other; and
the first fitting portion of the second fitting-portion group of one of the pair of the core sheets and the second fitting portion of the second fitting-portion group of the other of the pair of the core sheets fitted to each other.
